(19) United States
(12) Patent Application Publication
(10) Pub. No.: US 2003/0121800 A1
(43) Pub. Date: Jul. 3, 2003

(54) Sensor element of a gas sensor for determining gas components

(76) Inventors: Thomas Wahl, Pforzheim (DE); Thomas Brinz, Bissingen (DE); Hermann Dietz, Gerlingen (DE)

Correspondence Address: KENYON & KENYON, ONE BROADWAY, NEW YORK, NY, 10004, US

(21) Appl. No.: 10/168,607

(22) PCT Filed: Dec. 20, 2000
(86) PCT No.: PCT/DE00/04555

(30) Foreign Application Priority Data
Dec. 24, 1999 (DE) 199 63 008.9

(51) Int. Cl. G01N 27/26

(52) U.S. Cl. 205/780.5; 204/424; 204/431; 205/783.5

(57) ABSTRACT

A sensor element of a gas sensor is used for determining the concentration of hydrogen or a hydrogen-containing gas component, preferably ammonia or hydrocarbons, present in a gas mixture. It has a measuring electrode (13) exposed to the gas mixture and at least one reference electrode (14), both electrodes being applied to a proton-conducting solid electrolyte (11a), the solid electrolyte (11a) being made of a purely ceramic material.

The present invention relates to a sensor element of a gas sensor for determining the components of a gas, as is known from U.S. Pat. No. 4,689,122, for example.

### BACKGROUND INFORMATION

In the course of development of motor vehicles that have low fuel consumption and are environmentally friendly, internal combustion engines operated with an excess of air are being used to an increasing extent. One problem with this lean mode of operation, however, is that the exhaust gas has a definite excess of nitrogen oxides.

Under operating conditions that correspond to an air/fuel ratio of lambda=1, nitrogen oxides are mostly converted to nitrogen, water and carbon dioxide by reducing components such as hydrocarbons which are also present in the exhaust gas. However, sufficient quantities of reducing components are not available in the exhaust gas during lean operation, so the excess nitrogen oxides must be eliminated by another method. One known method is controlled metered addition of ammonia or ammonia-producing substances into the exhaust gas stream. This is done in the direction of the exhaust gas upstream from an additional catalytic converter on whose surface the reaction of nitrogen oxides with ammonia to form nitrogen and water takes place. To be able to use this SCR method (selective catalytic reduction method) effectively, the metered quantity of ammonia must be adjusted as accurately as possible to the excess of nitrogen oxides. Sensitive and selective gas sensors are needed for this purpose.

A gas sensor with the help of which it is possible to determine the concentration of hydrogen or hydrogen-containing compounds is described in U.S. Pat. No. 4,689,122. This sensor has a measuring gas space and a reference gas space, separated from one another by a proton-conducting solid electrolyte membrane. A measuring electrode is situated on the measuring gas side of the membrane, and a reference electrode is situated on the reference gas side. Both electrodes are made of platinum and are catalytically active. The solid electrolyte membrane is composed of a mixture of organic polymers with heteropoly acids or the salts thereof.

U.S. Pat. No. 4,664,757 describes a gas sensor based on the same measurement principle. It is-also based on a solid electrolyte membrane, which in this case is made of two different polymer components.

Solid electrolyte membranes based on organic polymer components, however, have the disadvantage that the respective gas sensor must not be operated at high temperatures for stability reasons. For use at temperatures of 300° C. to 600° C., gas sensors based on ceramic solid electrolytes are suitable. These are usually based on oxidic materials and therefore function as oxygen ion conductors within electrochemical measuring cells. This is problematical because only oxygen-containing gas components are determined by using this solid electrolyte. Compounds such as hydrogen or hydrocarbons may be determined only indirectly because they do not contain any chemically bound oxygen.

To measure specifically the concentration of hydrogen-containing components of a gas, the use proton-conducting ceramics as the solid electrolyte would be desirable. Gas sensors based on ceramic proton-conducting solid electrolytes (Nasicon) are already known. They are described, for example, in U.S. Pat. No. 5,672,258 and U.S. Pat. No. 5,393,404 and they may be operated at temperatures of 350° C. to 600° C. However, the solid electrolytes used there permit only a determination of moisture in gas mixtures.

### ADVANTAGES OF THE INVENTION

The sensor element according to the present invention having the features of claim 1 has the advantage that the sensor element may be operated at higher temperature such as those customary in the exhaust gases of internal combustion engines. In addition, the concentrations of hydrogen-containing gas components as well as of hydrogen may be determined without any cross-sensitivities to water or oxygen-containing compounds.

Advantageous refinements of and improvements on the sensor element characterized in the main claim are possible through the measures characterized in the subclaims. Thus, for example, the use of a catalytically inactive measuring electrode permits the use of a gas sensor as a disequilibrium sensor, i.e., an instantaneous determination of the gas components to be measured in the atmosphere of the gas mixture is possible without the result being falsified by catalytic processes taking place on the surface of the electrode.

Another advantage is that when using a catalystically inactive measuring electrode, the reference electrode may also be exposed directly to the gas mixture. This increases flexibility in sensor design.

Use of second reference electrode is especially advantageous because it permits a completely currentless measurement of the voltage between the measuring electrode and the reference electrode and thus further increases the measuring accuracy of the sensor element.

### DRAWING

One embodiment of the present invention is illustrated in the drawing and explained in greater detail in the following description.

FIG. 1 shows a cross section through a sensor element according to the present invention, and

FIGS. 2 and 3 show cross sections through sensor elements according to two additional embodiments.

### DESCRIPTION OF THE EXEMPLARY EMBODIMENTS

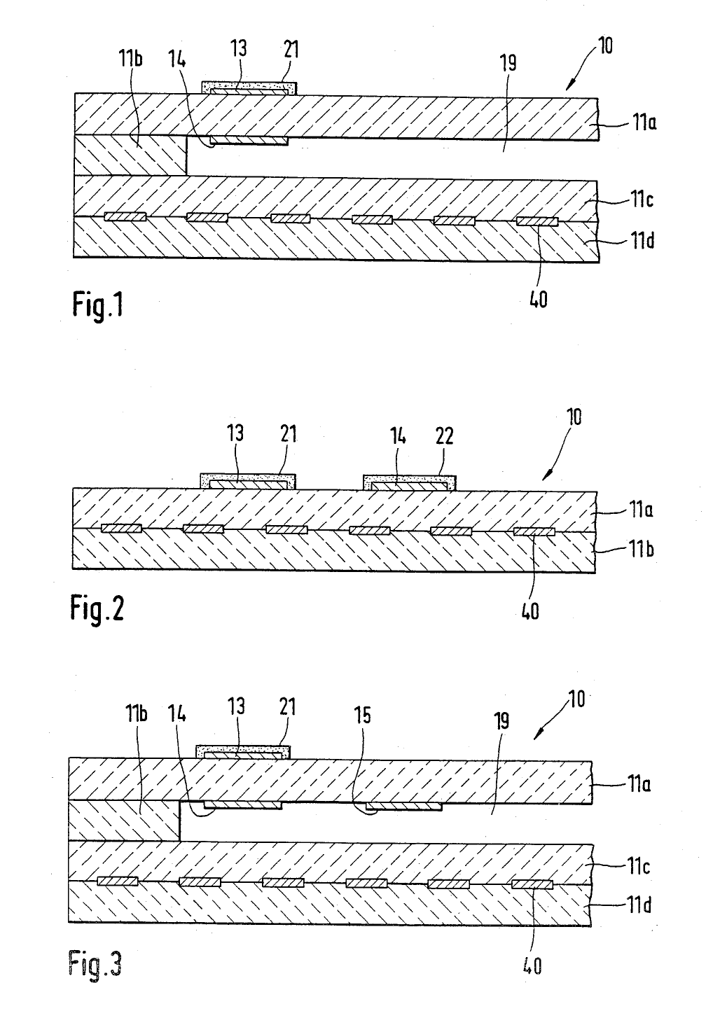

FIG. 1 shows a schematic diagram of a first embodiment of the present invention. A planar sensor element 10 of an electrochemical gas sensor has a proton conducting solid electrolyte layer 11a. In addition, other solid electrolyte layers 11b, 11c, 11d which may be made of the same material as solid electrolyte layer 11a, for example are also provided. All solid electrolyte layers 11a-11d are designed as ceramic films and form a planar ceramic body. The integrated form of the planar ceramic body of sensor element 10 is produced in a known way by laminating the ceramic films, which have been imprinted with function layers, and then sintering the laminated structure in a known manner. Solid electrolyte layer 11a is made of a proton-conducting ceramic material such as CeO₂. Alkaline earth oxides such as CaO, SrO and BaO may be used as dopants.

Sensor element 10 has an air reference channel 19 (e.g., in additional layer plane 11b), which originates at one end of the planar body of sensor element 10 and communicates with the air atmosphere. However, it is also possible to bring air reference channel 19 into contact with a reference gas atmosphere such as hydrogen.

A measuring electrode 13, which may be covered with a porous protective layer 21, is provided on the outer side of solid electrolyte layer 11a directly facing the gas mixture. The protective layer is made of a gas-permeable, porous and catalytically inactive material such as Al₂O₃ or CeO₂.

To guarantee that the gas components to be determined do not react on measuring electrode 13, electrode 13 is made of a catalytically inactive material. Suitable materials include, for example, gold, palladium, silver, and ruthenium. However, alloys or mixtures thereof may also be used, optionally with the addition of platinum.

A reference electrode 14 is provided on the side of solid electrolyte layer 11a facing air reference channel 19. This reference electrode is made of a catalytically active material such as platinum. The electrode material for both electrodes is used in the form of a cermet in a known manner so that it will sinter with the ceramic films.

Furthermore, a resistance heater 40 is embedded between two electric insulation layers (not shown here) in the ceramic base body of sensor element 10. The resistance heater is used to heat sensor element 10 to the required operating temperature of approx. 500° C. Essentially the same temperature prevails at electrodes 13, 14, which are in close proximity.

When using sensor element 10 as the gas sensor for determination of hydrogen or hydrogen-containing compounds, electrodes 13, 14 are operated as a Nernst cell, where the electromotive force EMF between the measuring electrode and the reference electrode is measured as a voltage. EMF is induced by the difference in hydrogen, i.e., proton concentration on the measuring electrode and on the reference electrode (Nernst principle). The magnitude of the voltage measured provides information about the hydrogen, i.e., proton concentration at the measuring electrode.

The voltage signal of sensor element 10 does not of course show any cross-sensitivities with oxygen-containing compounds because of the proton-conducting electrolytes used. However, one might assume that water, which is present in large amounts in an exhaust gas, would influence the potential of measuring electrode 13. However, experience has shown that the relatively constant percentage of water in the exhaust gas results in a constant high baseline in the voltage measurement, and therefore it does not affect the determination of the concentration of other hydrogen-containing exhaust gas components.

Hydrogen and hydrogen-containing exhaust gas components are often present in the exhaust gas stream in addition to oxidizing gases such as nitrogen oxide. If hydrogen-containing components are determined in the presence of oxidizing gases, an important prerequisite is that the surface of the measuring electrode 13 must not have any catalytic activity. Such an electrode is known as a disequilibrium electrode.

These prerequisites do not apply to reference electrode 14, which is made of a catalytically active platinum layer and functions as an equilibrium electrode because it acts as a catalyst in establishing a thermodynamic equilibrium of the gas-components at its surface.

The combination of a catalytically inactive measuring electrode 13 with a catalytically active reference electrode 14, however, also makes it possible to install the reference electrode directly in the exhaust gas stream.

Such a design of sensor element 10 is illustrated in FIG. 2. The voltage measured here corresponds to the difference between the disequilibrium potential on measuring electrode 13 and the equilibrium potential on reference electrode 14 and makes it possible to determine the concentration of hydrogen-containing compounds in the gas mixture. Reference electrode 14, like measuring electrode 13, is coated with a protective layer 22 against impurities. The advantage of this arrangement is the simplified sensor design because no air reference channel is needed.

Theoretically, such a concentration cell composed of a measuring electrode and a reference electrode is operated in a currentless operation. In reality, however, small current flows nevertheless occur and may affect the voltage signal. Therefore, according to another embodiment, a second reference electrode 15, as illustrated in FIG. 3, is incorporated into sensor element 10. This permits currentless voltage measurement between measuring electrode and additional reference electrode 15 because for geometric reasons, with an arrangement according to FIG. 3, there is a current flow between measuring electrode 13 and first reference electrode 14.

What is claimed is:

1. A sensor element of a gas sensor for determining the concentration of hydrogen or a hydrogen-containing gas component, preferably ammonia or hydrocarbons, present in a gas mixture, having at least one measuring electrode which is exposed to the gas mixture and at least one reference electrode, both electrodes being applied to a proton-conducting solid electrolyte, the solid electrolyte being a purely ceramic material,
wherein the solid electrolyte (11a) contains CeO₂.

2. The sensor element according to claim 1,
wherein the solid electrolyte (11a) contains CaO, SrO, BaO or mixtures of these oxides.

3. The sensor element according to one of claims 1 or 2,
wherein the measuring electrode (13) is made of a catalytically inactive material.

4. The sensor element according to claim 3,
wherein the measuring electrode (13) contains Au, Pd, Ag, Pt and/or Ru.

5. The sensor element according to claim 3 or 4,
wherein the measuring electrode (13) is covered by a protective layer (21) containing aluminum oxide or cerium oxide.

6. The sensor element according to one of the preceding claims,
wherein the reference electrode (14) is made of a catalytically active material.

7. The sensor element according to one of claims 1 through 6,
wherein the reference electrode (14) is exposed to a reference gas atmosphere.

8. The sensor element according to one of claims 1 through 6,
wherein the reference electrode (14) is exposed to the gas mixture to be determined and is covered by a protective layer (22) which contains aluminum oxide and/or cerium oxide.

9. The sensor element according to one of claims 1 through 7,
wherein two reference electrodes (14, 15) exposed to a reference gas atmosphere are provided.

10. Use of a sensor element according to one of claims 1 through 9 for an ammonia sensor for regulating a denitrification catalyst according to the SCR (selective catalytic reduction) method in exhaust gases of internal combustion engines.
